(19) United States
(12) Patent Application Publication
(10) Pub. No.: US 2026/0111212 A1
(43) Pub. Date: Apr. 23, 2026

(54) ARTIFICIAL INTELLIGENCE (AI) BASED UPGRADE ASSESSMENT SYSTEM AND METHOD OF OPERATION THEREOF

(71) Applicant: TECH MAHINDRA LIMITED, Maharashtra (IN)

(72) Inventors: Mahesh SHIVRAM, Karnataka (IN); Tushar Arun PHADNIS, Maharashtra (IN); Bharat Kumar IDARA, Telangana (IN); Saket Anil APTE, Melbourne (AU); Sivakumar PERIYANNAN, Tamil Nadu (IN); Prabhu MARIAPPAN, Tamil Nadu (IN)

(21) Appl. No.: 19/187,277

(22) Filed: Apr. 23, 2025

(30) Foreign Application Priority Data
Oct. 18, 2024 (IN) 202421079471

(51) Int. Cl. G06F 8/65; G06F 16/2452

(52) U.S. Cl. CPC G06F 8/65; G06F 16/24522

(57) ABSTRACT

The present invention discloses an artificial intelligence (AI) based upgrade assessment system (100). The system (100) comprises the user interface (UI) (102) configured to receive the natural language queries from the users. The Orchestrator Agent is configured to orchestrate natural language to SQL process and decision making. The system (100) further integrates the LLM model (104) to interpret the context of the user's query and identify potential risks, challenges, and costs associated with upgrading to the platform. The Deep Learning (DL) models are applied to the data retrieved from the LLM (104), performing a comprehensive analysis to suggest retrofitting customizations and configurations that align with platform standards. The output provides detailed recommendations for system (100) retrofitting to users by avoiding manual code modifications and facilitates a smooth transition to the platform.

### CROSS REFERENCE TO RELATED APPLICATION AND PRIORITY

The present invention claims priority from Indian Patent Application number 202421079471 filed on date 18 Oct. 2024.

### FIELD OF THE INVENTION

The present invention relates to the field of upgrade assessment systems and more particularly to an artificial intelligence (AI) based upgrade assessment system and method of operation to provide automated code retro-fitment to make customizations compatible with Application Suite.

### BACKGROUND OF THE INVENTION

Traditionally, upgrading a Maximo system has been a complex and time-consuming process that requires extensive manual effort and deep expertise. The process typically begins with a detailed study of the existing system, which further involves analyzing the current configurations, customizations, and licenses. This is followed by mapping the traditional elements to the new IBM Maximo Application Suite (MAS) schema. Schema involves technical activities related to database structure, such as mapping old data models to the new MAS data models. The MAS may be a task that demands a high level of precision and an understanding of both the legacy and new systems. The manual nature of MAS process not only consumes a significant amount of time but also introduces the risk of errors, leading to potential rework and delays. Moreover, the upgrade project often necessitates substantial retreatment of customizations and configurations to ensure compatibility with the new MAS solution. This retreatment may be particularly challenging as it requires careful balancing of the proposed system's capabilities with the organization's specific requirements.

Therefore the current challenges increase anxiety and uncertainty for users. The extensive time and effort required for the upgrade raise concerns about the potential disruption to business operations, the involvement of numerous stakeholders, and the overall cost of the project. The fear of unexpected issues, extended downtime, and the possibility of unforeseen investments further complicate the decision-making process.

Hence to overcome the aforesaid drawbacks an artificial intelligence (AI) based upgrade assessment system is required.

### OBJECTS OF THE INVENTION

Main object of the present disclosure is to provide an artificial intelligence (AI) based upgrade assessment system to provide automated code retro-fitment to make customizations compatible with MAS.

Another object of the present disclosure is to provide the system configured to optimize data retrieval, automate report generation, and enhance decision-making processes by analyzing historical data. This comprehensive approach ensures that businesses can manage their assets more efficiently, reduce downtime, and make data-driven decisions

### SUMMARY OF THE INVENTION

Before the present campaign pacing with minimal integration is described, it is to be understood that this application is not limited to a particular an artificial intelligence (AI) based upgrade assessment system, as there may be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to the campaign pacing system. This summary is not intended to identify essential features of the claimed subject matter nor is it intended for use in determining or limiting the scope of the claimed subject matter.

The present invention discloses an artificial intelligence (AI) based upgrade assessment system. The system comprises a user interface (UI) configured to accept natural language queries from the users. An Orchestrator Agent may be a core component to orchestrate natural language to SQL process and decision making. The system further integrates a LLM model. The system further comprises set of custom tools for validating, connecting and retrieving results. In an embodiment, the custom tools may be referred to as query tools. The system further may comprises plurality of a planning component for complex queries. The system may comprises a retrofitter to generate code and automatically retro fit customizations.

The proposed invention collects extensive data from the existing Maximo environment. This data includes configurations, customizations, integrations, unused assets, and user information. The invention utilizes a Large Language Model (LLM) to interpret the context of the user's query and identify potential risks, challenges, and costs associated with upgrading to MAS. These may include data migration issues or compatibility concerns with custom code. In essence, the tool assesses the compatibility of the existing system components such as customizations, databases, and integrations with MAS.

The Deep Learning (DL) models are applied to the data retrieved from the LLM, performing a comprehensive analysis to suggest retrofitting customizations and configurations that align with MAS standards. The output from this stage provides detailed recommendations for system retrofitting to users by avoiding manual code modifications and facilitates a smooth transition to MAS.

In an embodiment, a present invention provides a system (100) for artificial intelligence (AI)-based platform upgrade assessment comprises a user interface (102) configured to accept natural language queries or inputs from at least one user. It includes a database (106) operably coupled to the user interface (102) to store data, including maintenance records, equipment status, historical performance logs, and upgrade histories, which are used for analysis and decision-making. The system features a central processing hub (114) integrated with a Predictive AI (120) and a plurality of agents (112, 116), all coupled to the user interface (102) and the database (106, 122). The hub is designed to receive queries from the user interface (102) and pre-process these queries to identify intent and extract relevant entities. Pre-processed queries are distributed to at least the AI agents (112, 116, 122), utilizing a large language model (LLM) (104) to interpret the queries and provide expert insights. The responses from the agents (112, 116, 122) are processed to gather relevant information and insights based on user queries. The Predictive AI (120) analyzes the processed responses from the agents (112, 116, 122) against data from the database (106) to forecast potential issues and recommend preventative maintenance actions. Insights and recommendations generated from the analysis by the Predictive AI (120) are provided back to the user interface (102) for user review. The system compiles the processed information into comprehensive reports summarizing platform status updates, predicted maintenance needs, and performance analytics for presentation to the user. It also creates a feedback loop by sending information back to the agents (112, 116) to ensure continuous learning and improvement of the system's responses based on historical data and user interactions.

In yet another embodiment, the present invention provides an agent (112, 114) that assigns tasks to specialized agents. The specialized agent comprises a Maximo expert agent (112) for handling complex asset management tasks and a query agent (116) for managing database-related queries.

In still another embodiment, the present invention provides a central processing hub (114) which includes a retrofitting assignment agent (122) configured to provide insights based on user queries derived from the deep learning models of the Large Language Model (LLM) (104) and evaluate whether the system (100) components, configurations, or workflows should be reused, modified, or replaced with standard functionalities.

In still another embodiment, the present invention provides system components comprise Maximo Business Objects (MBOs), automation scripts, Java classes, and integration components.

In yet another embodiment, the present invention provides involves pre-processing that generates the natural queries' corresponding SQL query, eliminating the need for manual SQL writing. This query is then executed against the relevant Maximo database or data source (106).

In yet another embodiment, the present invention provides a database comprises a history of upgrades database (122) that maintains a record of past system modifications, which is leveraged by the Predictive AI (120) to optimize asset management strategies.

In yet another embodiment, the present invention provides a ChReq orchestrator (121) configured to assign upgrade requests to AI agents for processing and workflow optimization.

In yet another embodiment, the present invention provides the ChReq Orchestrator (121) acts as the central controller, coordinating AI agents (112, 114) to analyze customizations and workflows while ensuring that all queries related to system updates and optimizations are handled efficiently.

In yet another embodiment, the present invention provides a parse tool (124) that translates natural language queries into structured SQL queries for automated database interrogation.

In an embodiment, a present invention provides a method for artificial intelligence (AI)-based platform upgrade assessment comprises accepting natural language queries or inputs from at least one user via a user interface (102). The method involves storing data in a database (106), which comprises maintenance records, equipment status, historical performance logs, and upgrade histories. Queries from the user interface (102) are received at a central processing hub (114), where they are pre-processed to identify intent and extract relevant entities. The pre-processed queries are distributed to at least the AI agents (112, 116, 122), utilizing a large language model (LLM) (104) to interpret the queries and provide expert insights. The responses from the agents (112, 116, 122) are processed to gather relevant information and insights based on the user queries. The Predictive AI (120) analyzes the processed responses from the agents (112, 116, 122) against the data from the database (106) to forecast potential issues and recommend preventative maintenance actions. Insights and recommendations generated from the analysis performed by the Predictive AI (120) are provided back to the user interface (102) for user review. The method further comprises compiling the processed information into comprehensive reports summarizing platform status updates, predicted maintenance needs, and performance analytics for presentation to the user. Additionally, a feedback loop is created by sending information back to the agents (112, 116) to ensure continuous learning and improvement of the system's responses based on historical data and user interactions.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure. The detailed description is described with reference to the following accompanying figures.

FIG. 1: illustrates an architecture of the proposed an Artificial Intelligence (AI) based Maximo Upgrade Assessment system in a preferred embodiment of the present invention.

FIG. 2: illustrates a block diagram of the another embodiment of the system as illustrated in FIG. 1.

FIG. 3: illustrates an AI-powered Maximo system analysis and automation framework designed to enhance the management of IBM Maximo.

FIG. 4: illustrates the flowchart i.e., a method performing the steps for upgrading assessment platform of the AI-based system in a preferred embodiment of the present invention.

FIG. 5: illustrates the flowchart i.e., a method for operating the upgrading assessment platform of the AI-based system in a preferred embodiment of the present invention.

The figure depicts various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein. Following is a list of elements and reference numerals used to explain various embodiments of the present subject matter.

| Reference Numeral | Element Description |
|---|---|
| 100 | System |
| 102 | User interface |
| 104 | Large language model (LLM) |
| 106 | Database |
| 108 | Tasks |
| 110 | File Reader Tool |
| 112 | Maxima Agent |
| 114 | Crew of Agents or inference engine or AI-powered |
| | engine or central processing |
| 116 | Query Agent |
| 118 | Query Tool |
| 120 | Predictive Artificial Intelligence (AI) model |
| 121 | ChReq Orchestrator |
| 122 | Retrofitting Assignment Agent |
| 123 | Customer Maximo Environment |
| 124 | Parse tool |

The proposed system (100) streamlines and enhances the platform upgrade process by leveraging artificial intelligence to provide insightful analysis, accurate forecasting, strategic planning, and automated code retro-fitment to make customizations compatible with MAS. In an embodiment, the platform may be referred to as IBM Maximo. This system (100) is designed to assess existing platform environments, identify potential upgrade challenges, and recommend tailored solutions that optimize both cost and efficiency. The system (100) simplifies decision-making for enterprises by offering predictive insights, thus ensuring a smoother, faster, and more reliable upgrade path for platform implementations. It serves as an indispensable resource for organizations seeking to maximize the value of their asset management systems while minimizing the risks and complexities associated with upgrades.

The proposed system (100) automates the assessment and planning phases of the Maximo upgrade. The system (100) reduces the manual workload, minimizes errors, and provides users with clear, data-driven insights. The system (100) may accelerate the upgrade process and offer a transparent and predictable upgrade path. The system (100) may automate the retreatment of customizations to make them compatible with MAS. The system (100) ultimately transforms a traditionally daunting process of upgrade assessment into a manageable, efficient, and strategic initiative, enabling businesses to unlock the full potential of their Maximo systems with minimal disruption and maximum return on investment.

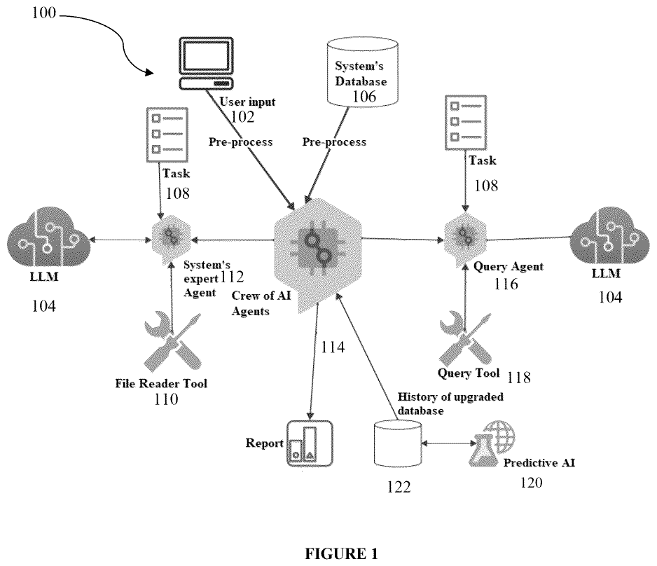

Referring to FIG. 1, an architecture of the proposed system (100) is illustrated. The system (100) comprises a user interface (UI) (102) to accept natural language queries or inputs from the users. The queries or inputs may be technical or non-technical in nature. These inputs may also include maintenance requests, asset status updates, queries related to asset performance, or requests for predictive maintenance recommendations. These inputs are preprocessed and then sent to the Crew of AI Agents (114), which acts as the central processing hub. The central processing hub (114) is responsible for distributing tasks to specialized agents, ensuring that each task is handled by the most appropriate AI component.

A database (106) serves as the central repository for all asset-related data, including maintenance records, equipment status, historical performance logs, and upgrade histories. This database is configured for providing the historical data needed for predictive maintenance and decision-making. Data from the Maximo database (106) (also referred as database (106) is preprocessed and sent to the central processing hub (114), where it is utilized by the Query A gent (116) to fetch relevant information for user requests. The Predictive AI also leverages this historical data to forecast potential issues, enabling preventative maintenance and reducing operational costs.

The central processing hub (114) is the core AI processing unit that coordinates the workflow. It receives preprocessed data from both user Inputs (102) and the database (106) and assigns tasks to the maximo expert agent (112) and the query agent (116). The maximo expert agent (112) specializes in handling complex asset management tasks, utilizing an LLM to understand technical data and provide expert-level insights. It also employs a file reader tool maximo expert agent (110) to analyze uploaded documents such as maintenance logs, reports, or manuals. The query agent (116), on the other hand, manages all database-related queries, using a query tool (118) to fetch relevant data from the maximo database (106) and interacting with an LLM (104) to refine and interpret user queries.

Large Language Models (LLM s) (104) in this system enables Natural Language Processing (NLP) capabilities. Both the maximo expert agent (112) and the query agent (116) to understand user queries, interpret technical documents, and refine search results use these Large Language Models (LLM s). This reduces the need for manual analysis and ensures that the system can process complex queries intelligently.

A history of upgrades database (122) maintains records of past system upgrades and maintenance logs, which are analyzed by the Predictive AI (120) to predict future failures and maintenance needs. The Predictive AI (120) pulls data from both the history of upgrades database (122) and the maximo database (106), generating insights that are sent back to the Crew of AI Agents (114) for further processing. This predictive capability is essential for preventative maintenance, helping businesses avoid unexpected downtime and reduce costs.

Finally, the report generation component compiles all the processed information into comprehensive reports for users. These reports may include asset status updates, predicted maintenance needs, and performance analytics. By summarizing critical data, these reports provide clear, actionable insights to business stakeholders, enhancing efficiency in asset management.

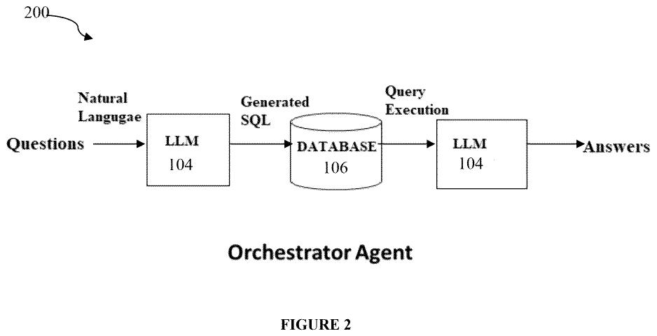

Referring to FIG. 2, an embodiment of the system (100) is illustrated. The system (100) comprises a user interface (UI) (102) to accept natural language queries or inputs from the users. The queries or inputs may be technical or non-technical in nature. These inputting a question in natural language regarding specific details about their current maximo system. The AI-powered engine (114) interprets the user's query and automatically generates the corresponding SQL query, eliminating the need for manual SQL writing. This query is then executed against the relevant database or data source (106). The results are returned to the user in a clear, understandable format, providing precise data that forms the foundation for the subsequent analysis and upgrade planning. The collected data then forwards to the deep learning (DL) models of the LLM s (104) employed to conduct a more in-depth analysis of the underlying data structures, workflows, and system interactions within the Maximo environment. These models go beyond basic NLP and LLMs, enabling a thorough examination of structured data. The DL models also compare the existing system implementation with the industry-standard configurations in the Maximo Application Suite (MAS). Based on this comparison, the tool suggests specific retro fitments to align the current system with the MAS industry flavor, ensuring compatibility and optimization in the upgraded environment. This stage provides critical insights and actionable recommendations that inform the upgrade strategy.

In the final stage, machine learning (ML) algorithms analyze the patterns identified by the LLM (114). These patterns include recurring issues, common workflows, and typical customization challenges. The models learn from these patterns, building a knowledge base that helps anticipate similar issues in other Maximo environments. The models are continuously trained on new data and insights from each system run, enabling the tool to adapt to new areas of the Maximo system and remain effective as the system evolves. This iterative process enhances the tool's efficiency and accuracy with each use, reducing the time and effort required for analysis while increasing the reliability of upgrade assessments. The insights gained feedback into the tool's knowledge base, ensuring continuous improvement.

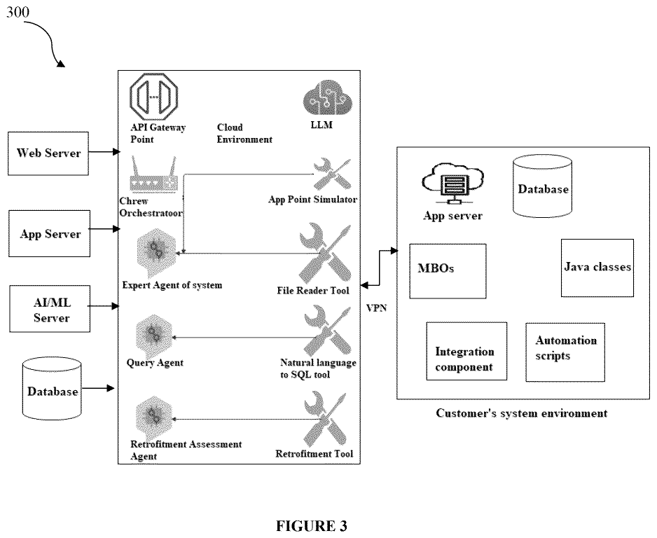

In another embodiment FIG. 3, an AI-powered Maximo system analysis and automation framework is designed to enhance the management of Maximo, an asset management system. By leveraging AI agents, tools, and automated processes, the system efficiently handles queries, analyzes customizations, and suggests optimizations. The architecture of the system (100) includes components such as the ChReq Orchestrator (121), Retrofitting Assignment Agent (122), and the Customer Maximo Environment (123), which work together to streamline the upgrade process.

The system (100) begins by receiving input from multiple sources, including APIs, remote methods, and databases (106). These inputs provide information about Maximo's configurations and workflows. The ChReq Orchestrator (121) acts as the central controller, coordinating AI agents (112,114) to analyze customizations and workflows while ensuring that all queries related to system updates and optimizations are handled efficiently. The ChReq Orchestrator (121) coupled with the Retrofitting Assignment A gent (122), which aligns existing Maximo customizations with industry-standard Maximo Application Suite (MAS) configurations. The Retrofitting Assignment Agent (122) evaluates customizations to determine whether they should be reused, modified, or replaced with standard functionalities to reduce system complexity and improve maintainability. The Retrofitting Assignment A gent (122) evaluates existing customizations to determine whether they should be reused, modified, or replaced, thereby minimizing redundant customizations and improving system maintainability.

In the middle layer, AI-powered processing occurs, where various components work together to analyze data and generate insights. An Inference Engine (114) detects patterns and inefficiencies, while a Parse Tool (124) converts natural language queries into structured SQL queries. The Intelligent Model-Based inference engine (114) identifies custom components needing adjustments during upgrades, and the Distributed Tool ensures efficient processing across multiple nodes. Together, these tools provide a seamless analysis of the system, enabling data-driven decisions regarding upgrades and maintenance.

The Customer Maximo Environment (123) represents the actual system used by the organization, including databases, custom components, and automation scripts. The AI agents (112,114) optimize these components to ensure alignment with best practices, rationalizing modifications to facilitate smoother upgrades. The system's key benefits include automated analysis, optimized customizations, faster upgrades, predictive maintenance, and continuous improvement through learning from new data. Overall, this AI-powered Maximo automation system significantly enhances the efficiency and effectiveness of asset management infrastructure.

Particularly, in FIG. 3, the system (100) receives queries and data from multiple input sources such as APIs, which include external applications or users interacting with the system and sending queries or requests for system analysis. The system also utilizes RMI (Remote Method Invocation) methods for remote execution of methods, and databases (106) that contain structured Maximo system data, such as asset configurations, maintenance history, and workflow details. In other words, the user or system submits a query via API, RMI, or direct database access.

The Parse Tool (124) translates natural language queries into structured SQL queries for analysis. The query is passed to the Change Request Orchestrator (121) (ChReq Orchestrator) for further analysis and coordination.

The ChReq Orchestrator (121) assigns the request to relevant AI agents (112, 114) for processing. The Inference Engine (114) analyzes queries, workflows, and database structures to detect patterns and inefficiencies. The intelligent model based inference engine (114) uses deep learning to identify analyzes queries, workflows, and database structures to detect patterns and inefficiencies that may need adjustments during system (100) upgrades. The retrofitting assignment agent (122) evaluates customizations in system (100) and determines whether they should be reused, modified, or replaced with standard functionalities.

Additional tools like the Distributed Tool ensure efficient handling of complex system queries by distributing AI processing across multiple nodes.

AI agents generate reports with actionable insights, including recommendations for customizations that should be removed, workflows that may be improved, and integration components that need updates.

Based on the AI-generated insights, recommended changes are either automatically implemented into the Customer Maximo Environment (123). The Customer Maximo Environment (123), represents the actual system (100) used by the customer, which includes database act as a repository for all system data, such as asset records, maintenance history, and custom maximo business objects (MBOs). The Customer Maximo Environment (123) includes automation scripts, java classes, and integration components that define how system operates.

The AI-powered Maximo system analysis and automation framework (100) receives queries from various input sources (106), processes them using AI agents and tools (112, 114), generates optimization recommendations (122), and implements changes in the customer environment (123). This leads to improved efficiency, reduced manual effort, and optimized Maximo customizations.

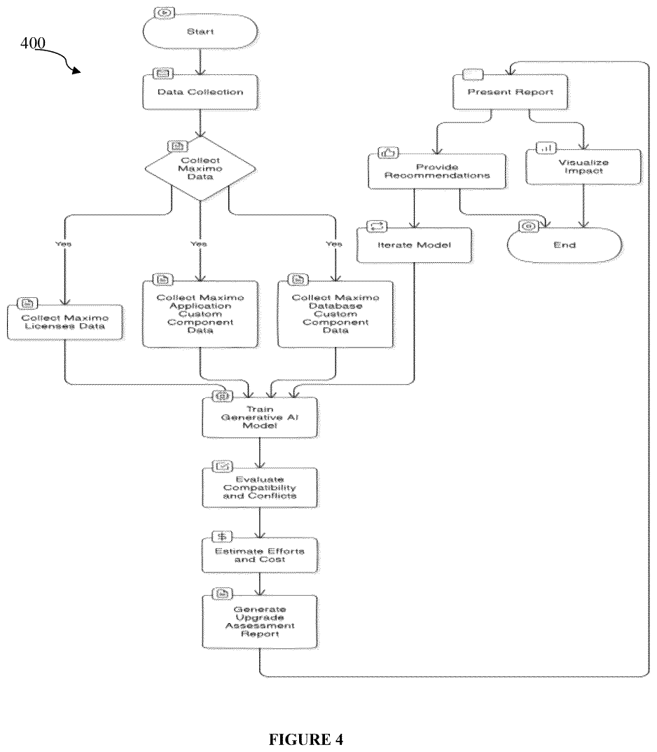

FIG. 4 illustrates a flow chart performing a method (600) for operating the artificial intelligence (AI)-based platform upgrade assessment system, in accordance with an embodiment of the present subject matter. The order in which the method (600) may be described may be not intended to be construed as a limitation, and any number of the described method blocks may be combined in any order to implement the method (600) or alternate methods. Additionally, individual blocks may be deleted from the method (600) without departing from the spirit and scope of the subject matter described herein. Furthermore, the method may be implemented in any suitable hardware, software, firmware, or combination thereof. However, for ease of explanation, in the embodiments described below, the method (600) may be considered to be implemented as described in the artificial intelligence (AI)-based platform upgrade assessment system.

At block 401, the system collects an extensive dataset from the existing platform environment, encompassing configurations, customizations, and user data. The data collection process is divided into three key areas such as system licenses data: This area assesses the number of users, entitlements, and potential cost optimizations, custom component data: This pertains to custom application components, such as scripts, which are configured to reflect modifications made to the Maximo system applications and evaluate their compatibility with upgrades. Lastly, a systems (100) database-related data: This data helps identify database-level customizations that may affect performance or upgrade compatibility.

At block 403, once all necessary Maximo data is collected, the system, trains a Generative AI Model to analyze patterns, identify compatibility issues, and recommend optimizations. This model learns from past upgrade scenarios and identifies potential conflicts that may arise during the upgrade. The AI-driven approach enhances decision-making, reduces manual effort in assessing Maximo upgrades, and determine efforts and cost required for the updation of the system. At the output, based on the analysis of AI model, the system generates a comprehensive report that serves as a decision-making document or provide recommendation to stakeholders to proceed with the upgrade strategy.

If further refinements are needed, the system re-trains the AI model with additional data to improve accuracy. This iterative process ensures that recommendations are continuously refined and improved.

In an embodiment, this deployment architecture ensures that the Maximo Upgrade System (100) can effectively assess and plan upgrades while respecting the user's need to maintain their core Maximo system (100) on-premises/over cloud. It provides a clear picture of how the new upgrade components interact with the existing Maximo setup to achieve the required functionality.

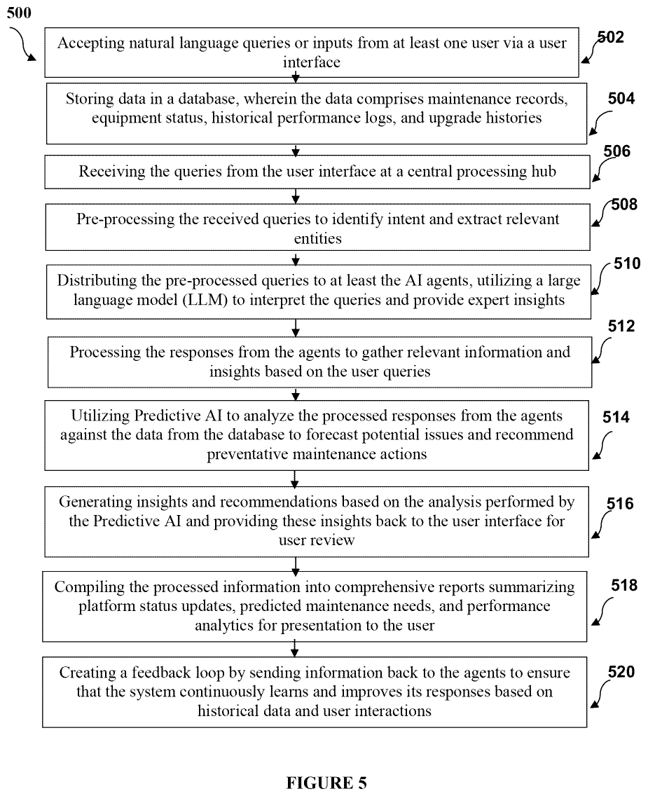

FIG. 5 illustrates a flow chart performing a method (500) for operating the upgrading assessment platform of the AI-based system, in accordance with an embodiment of the present subject matter. The order in which the method 500 is described is not intended to be construed as a limitation, and any number of the described method blocks may be combined in any order to implement the method 500 or alternate methods. Additionally, individual blocks may be deleted from the method 500 without departing from the spirit and scope of the subject matter described herein. Furthermore, the method may be implemented in any suitable hardware, software, firmware, or combination thereof. However, for ease of explanation, in the embodiments described below, the method 500 may be considered to be implemented as described in the system 100.

At block 502, accepting natural language queries or inputs from at least one user via a user interface (102).

At block 504, storing data in a database (106), wherein the data comprises maintenance records, equipment status, historical performance logs, and upgrade histories.

At block 506, receiving the queries from the user interface (102) at a central processing hub (114).

At block 508, pre-processing the received queries to identify intent and extract relevant entities.

At block 510, distributing the pre-processed queries to at least the AI agents (112, 116, 122), utilizing a large language model (LLM) (104) to interpret the queries and provide expert insights.

At block 512, processing the responses from the agents (112, 116, 122) to gather relevant information and insights based on the user queries.

At block 514, utilizing Predictive AI (120) to analyze the processed responses from the agents (112, 116, 122) against the data from the database (106) to forecast potential issues and recommend preventative maintenance actions.

At block 516, generating insights and recommendations based on the analysis performed by the Predictive AI (120) and providing these insights back to the user interface (102) for user review.

At block 518, compiling the processed information into comprehensive reports summarizing platform status updates, predicted maintenance needs, and performance analytics for presentation to the user.

At block 520, creating a feedback loop by sending information back to the agents (112, 116) to ensure that the system continuously learns and improves its responses based on historical data and user interactions.

### TECHNICAL ADVANTAGES

Platform's machine learning models continuously refine their understanding of the upgrade process with each system run. This iterative improvement enhances the tool's efficiency and reliability over time, resulting in increasingly accurate assessments and recommendations.
In addition to identifying areas for improvement, the platform proactively recommends specific retrofitments to align the current Maximo implementation with MAS's industry standards. This ensures that the upgraded system not only meets current needs but also adheres to best practices, creating a robust and future-proof solution.
The platform automates the complex assessment process, significantly reducing the time and effort required for planning and executing a Maximo upgrade.
The multiplier-based model provides reliable estimates for costs and timelines, ensuring that upgrade decisions are based on a comprehensive understanding of the system.
By predicting potential challenges and recommending proactive retrofitments, the platform minimizes the risk of unexpected issues during the upgrade, ensuring a smoother transition with minimal downtime.
As the tool continuously evolves, it remains effective in adapting to future upgrades and changes.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

Although implementations for the artificial intelligence (AI) based upgrade assessment system and method of operation thereof have been described in language specific to structural features and/or methods, it is to be understood that the appended claims are not necessarily limited to the specific features described. Rather, the specific features are disclosed as examples of implementation for the artificial intelligence (AI) based upgrade assessment system and method of operation thereof.

1. A system (100) for artificial intelligence (AI)-based platform upgrade assessment, comprising:
an user interface (102) configured to accept natural language queries or inputs from at least one user;
a database (106) operably coupled to the user interface (102) configured to store data, comprising maintenance records, equipment status, historical performance logs, and upgrade histories, which are utilized for analysis and decision-making;
a central processing hub (114) integrated with a Predictive AI (120), and a plurality of agents (112, 116), coupled to the user interface (102) and the database (106, 122), configured to:
receive the queries from the user interface (102);
pre-process the received queries to identify intent and extract relevant entities;
distribute the pre-processed queries to at least the AI agents (112, 116,122), utilizing a large language model (LLM) (104) to interpret queries and provide expert insights;
process the responses from the agents (112, 116, 122) to gather relevant information and insights based on the user queries;
utilize the Predictive AI (120) to analyze the processed responses from the agents (112, 116, 122) execute the response against the data from the database (106) to forecast potential issues and recommend preventative maintenance actions;
generate insights and recommendations based on the analysis performed by the Predictive AI (120) and provide these insights back to the user interface (102) for user review;
compile processed information into comprehensive reports summarizing platform status updates, predicted maintenance needs, and performance analytics for presentation to the user; and
create a feedback loop by sending information back to the agents (112, 116) to ensure that the system continuously learns and improves its responses based on historical data and user interactions.

2. The system (100) of claim 1, wherein the agent (112,114) assign tasks to specialized agents, the specialized agent comprises a maximo expert agent (112) for handling complex asset management tasks and a query agent (116) for managing database-related queries.

3. The system (100) of claim 1, wherein the central processing hub (114) comprises a retrofitting assignment agent (122) configured to provide insights based on the user queries derived from the deep learning models of the Large Language Model (LLM) (104) and evaluate whether the system (100) components, configurations, or workflows should be reused, modified, or replaced with standard functionalities.

4. The system (100) of claim 3, wherein the system components comprises Maximo Business Objects (MBOs), automation scripts, Java classes, and integration components.

5. The system (100) of claim 1, wherein the pre-processing involves generating the natural queries corresponding SQL query, eliminating the need for manual SQL writing. This query is then executed against the relevant maximo database or data source (106).

6. The system (100) of claim 1, wherein the database comprises a history of upgrades database (122) maintains a record of past system modifications, which is leveraged by the Predictive AI (120) to optimize asset management strategies.

7. The system (100) of claim 1, wherein the system comprises a ChReq orchestrator (121) configured to assign upgrade requests to AI agents for processing and workflow optimization.

8. The system (100) of claim 8, wherein the ChReq Orchestrator (121) acts as the central controller, coordinating AI agents (112,114) to analyze customizations and workflows while ensuring that all queries related to system updates and optimizations are handled efficiently.

9. The system (100) of claim 1, wherein the system comprises a parse tool (124) translates natural language queries into structured SQL queries for automated database interrogation.

10. A method for operating the artificial intelligence (AI)-based platform upgrade assessment, the method comprising:
accepting natural language queries or inputs from at least one user via a user interface (102);
storing data in a database (106), wherein the data comprises maintenance records, equipment status, historical performance logs, and upgrade histories;
receiving the queries from the user interface (102) at a central processing hub (114);
pre-processing the received queries to identify intent and extract relevant entities;
distributing the pre-processed queries to at least the AI agents (112, 116, 122), utilizing a large language model (LLM) (104) to interpret the queries and provide expert insights;
processing the responses from the agents (112, 116, 122) to gather relevant information and insights based on the user queries;
utilizing Predictive AI (120) to analyze the processed responses from the agents (112, 116, 122) against the data from the database (106) to forecast potential issues and recommend preventative maintenance actions;
generating insights and recommendations based on the analysis performed by the Predictive AI (120) and providing these insights back to the user interface (102) for user review;
compiling the processed information into comprehensive reports summarizing platform status updates, predicted maintenance needs, and performance analytics for presentation to the user; and
creating a feedback loop by sending information back to the agents (112, 116) to ensure that the system continuously learns and improves its responses based on historical data and user interactions.
